(19) United States
(12) Patent Application Publication
(10) Pub. No.: US 2025/0049011 A1
(43) Pub. Date: Feb. 13, 2025

(54) FISHING EQUIPMENT WITH ENHANCED SONAR DETECTION

(71) Applicant: John David Burkhardt, Clermont, FL (US)

(72) Inventor: John David Burkhardt, Clermont, FL (US)

(21) Appl. No.: 18/795,546

(22) Filed: Aug. 6, 2024

Related U.S. Application Data
(60) Provisional application No. 63/531,075, filed on Aug. 7, 2023.

(51) Int. Cl. A01K 91/00; A01K 85/00

(52) U.S. Cl. CPC A01K 91/00; A01K 85/00

(57) ABSTRACT

Fishing lures and lines to improve the capability of visually following an angler's lure while in the water are set forth. The lures and lines include the incorporation of materials that are sensitive to sonar imaging, and will highly define the underwater location of the fishing line on a sonar device's screen.

### CROSS-REFERENCE TO RELATED APPLICATIONS

This application claims the benefit of U.S. Provisional Patent Application No. 63/531,075, filed Aug. 7, 2023, which is incorporated by reference herein in its entirety.

### FIELD OF THE DISCLOSURE

The present disclosure relates to fishing equipment providing enhanced visibility when using sonar devices.

### BACKGROUND

Sonar, (an acronym of “sound navigation ranging”) is a technique that uses sound propagation (usually underwater) to navigate, measure distances (ranging), communicate with or detect objects on or under the surface of the water. Sonar is so widely used by anglers all over the world today that it is easy to overlook the fact that the technology is well over a century old. It is believed that the sinking of the RMS Titanic in 1912 provided the first motivation for the use of underwater acoustic ranging technology. The Fessenden oscillator was developed shortly thereafter, and was in use by the U.S Coast Guard to detect icebergs and hazards to navigation on the sea floor as early as 1914. The need to detect the presence of submarines in World Wars I and II greatly accelerated research and development around SONAR.

Although there were some fishing vessels using sonar to detect fish and marine mammals in the 1930's, the application of sonar to commercial fishing did not become widespread until the Postwar period. Since that time, fishermen have made great use of sonar devices, typically referred to as “fish finders”, to locate fish. Early iterations of fish finders were able to locate schools of fish, but recent developments in the technology in some cases allows/has enabled location of individual fish, or even the fish's species. Furthermore, while early fish finder equipment was bulky and expensive, current technology has allowed anglers to employ small, inexpensive sonar devices that interact with apps on their smartphones.

Sonar devices applied to fishing have been primarily used to locate fish. However, it has been recognized in the art that it is also advantageous to determine the location of the angler's line and lure in relation to the location of the targeted fish.

Most of the line and lure locating devices in existing patent involve an exterior source of illumination. For example, U.S. Pat. No. 461,775 to Johansson describes fishing tackle for catching fish with a fishing line constituting a light guide, at one end of which the light from a natural or artificial light source can be focused, and at the other end of which a bait with reflecting, luminescent, transmittent or light-scattering properties is located.

In another example. U.S. Pat. No. 8,402,686 is directed to a light emitting fishing teaser with a translucent lure head, an enable terminal, a charging terminal, a ground terminal, an energy source, a control circuit hoard, a light emitting circuit board, a convex lens formed by an outside surface of the translucent lure head, a leader secured to a fishing line and extending through the cylindrical lure cavity and connecting to a fishing lure, and a lure skirt. A plurality of light emitting fishing teasers disposed on a leader forming a daisy chain of light emitting fishing teasers.

In another example, US20230095841 relates to a sonar reflective fishing lure or terminal tackle that includes a body, sonar reflective surfaces that are raised from the exterior body or recessed in the exterior body, and a hook connected to the exterior body. The sonar reflective surfaces face in different directions, which causes the fishing lure or terminal tackle to have enhanced sonar reflectivity and allows at least some of the reflective surfaces to be contacted by a sonar beam of a fish finder regardless of the positioning of the fishing lure or terminal tackle relative to the sonar beam.

It can be seen from the foregoing that the need exists for easily-used fishing equipment that enables anglers to use sonar devices to identify and locate their fishing line and lures underwater.

### SUMMARY

The present disclosure relates to fishing equipment providing enhanced visibility when using sonar devices. In an exemplary embodiment, the disclosure can include fishing line providing enhanced sonar visibility. The fishing line can comprise a first material constructed from at least one material providing sufficient strength and flexibility to enable angling for the specific species being sought and the conditions under which angling is being performed; and a second material composed of at least one substance that is more sensitive to sonar imaging than the first material. The second material is chosen from a group comprising metals and Mylar®, and the fishing line can be made from extruded materials.

The second material can be provided as particles distributed within the fishing line, or the first material and second materials can be coextruded to form inner and outer layers. The fishing line can be provided as a braided line composed of multiple strands, at least one of the strands being constructed from the first material, and at least one of the strands being constructed from the second material.

The second material can be chosen from a group comprising aluminum, steel, lead, and Mylar®. A fishing lure providing enhanced sonar visibility is also described. The fishing lure includes a lure body and other components, with at least one section of the lure body or other component including a material more sensitive to sonar imaging than the material from which the lure body or other components are made. The at least one section including a material more sensitive to sonar imaging can be provided as a coating or as an appliqué.

### BRIEF DESCRIPTION OF THE DRAWINGS

FIG. 1 illustrates a first exemplary extruded fishing line providing enhanced sonar visibility constructed in accordance with the principles herein.

FIG. 2 illustrates a second exemplary extruded fishing line providing enhanced sonar visibility constructed in accordance with the principles herein.

FIG. 3 illustrates a third exemplary extruded fishing line providing enhanced sonar visibility constructed in accordance with the principles herein.

FIG. 4 illustrates an exemplary braided fishing line providing enhanced sonar visibility constructed in accordance with the principles herein.

FIG. 5 illustrates a first exemplary embodiment of a fishing lure providing enhanced sonar visibility constructed in accordance with the principles herein.

FIG. 6 illustrates a second exemplary embodiment of a fishing lure providing enhanced sonar visibility constructed in accordance with the principles herein.

### DETAILED DESCRIPTION

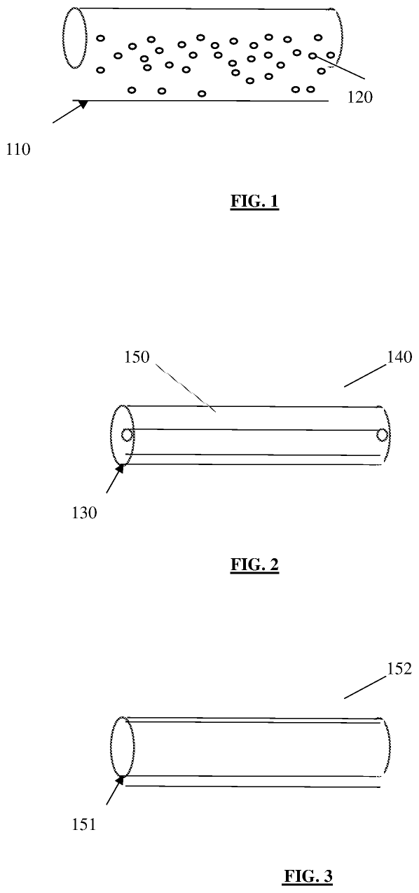

FIG. 1 illustrates a fishing line 110 formed from extruded materials. The extruded line 110 is constructed from materials providing sufficient strength and flexibility to enable angling for the specific species being sought and the conditions (temperature, fresh or salt water, etc.) under which angling is being performed. Such materials include, but are not limited to, monofilament, copolymer, multi-polymers and all configurations/combinations of fluorocarbon materials. Additional material 120 is incorporated into the line 110 during the extrusion process. The material 120 is composed of substances that are more sensitive to sonar imaging than the material or materials from which the line 110 would constitute without the material 120, and will highly define the underwater location of the fishing line on a sonar device's screen. The materials 120 can be chosen as a single material or combination of one or more additives. These additives would include but are not limited to: metals, Mylar® or other sonar reflective products that would allow for underwater visibility of the fishing line on sonar devices. Although the material 120 is illustrated as being particles distributed within the line 110, it is contemplated that the material 120 could be provided in any suitable shape.

FIG. 2 illustrates a fishing line 130 formed from extruded materials. The line 130 comprises an inner layer of material 150 and an outer layer of material 140. The inner layer of material 150 and outer layer of material 140 are coextruded to form a single line using known coextrusion processes. The outer layer 140 is constructed from materials providing sufficient strength and flexibility to enable angling for the specific species being sought and the conditions (temperature, fresh or salt water, etc.) under which angling is being performed. Materials typically used in extruded lines include monofilament, copolymer, multi-polymers and all configurations/combinations of fluorocarbon materials. The inner material 150 is coextruded with the outer material 140 re incorporated into the line 130 during the extrusion process. The inner material 150 is composed of a substance or substances that are sensitive to sonar imaging, and will highly define the underwater location of the fishing line on a sonar device's screen. The substance comprising the material 150 can be chosen as a single material or combination of one or more additives. These additives would include but are not limited to: metals, Mylar® or other sonar reflective products that would allow for underwater visibility of the fishing line on sonar devices.

FIG. 3 illustrates a fishing line 151 formed from extruded materials. The line 151 is provided with a coating 152. The line 151 is constructed from materials providing sufficient strength and flexibility to enable angling for the specific species being sought and the conditions (temperature, fresh or salt water, etc.) under which angling is being performed. Materials typically used in extruded lines include monofilament, copolymer, multi-polymers and all configurations/combinations of fluorocarbon materials. The coating 152 is composed of a substance or substances that are sensitive to sonar imaging, and will highly define the underwater location of the fishing line on a sonar device's screen. The substance comprising the coating can be chosen as a single material or combination of one or more additives. These additives would include but are not limited to: metals, Mylar® or other sonar reflective products that would allow for underwater visibility of the fishing line on sonar devices.

FIG. 4 illustrates a braided fishing line 160, here shown as a first braided strand 170, a second braided strand 180, and a third braided strand 190. Although the braided fishing line 160 is shown as a three-strand line, it is to be understood that this is for illustrative purposes only, and that fishing line embodying the principles of line 160 could be manufactured with any number of strands desired.

First braided strand 170 and second braided strand 180 are constructed from materials providing sufficient strength and flexibility to enable angling for the specific species being sought and the conditions (temperature, fresh or salt water, etc.) under which angling is being performed. Suitable braided line materials include, but are not limited to, Nylon, Dacron, Spectra, or Dyneema. The third braided strand 190 is made from a substance or substances sensitive to sonar imaging, and will highly define the underwater location of the fishing line on a sonar device's screen. The third braided strand 190 would be incorporated in the manufacturing process, which can be chosen as any suitable line braiding process. The third braided strand 190 could be composed of a single material or a combination of materials. Suitable materials include, but are not limited to: aluminum, steel, lead, Mylar®, silver or other sonar reflective materials. It is also contemplated that the third braided strand 190 could be composed of a strand constructed in accordance with the principles described hereinabove with respect to FIG. 1, FIG. 2, and/or FIG. 3.

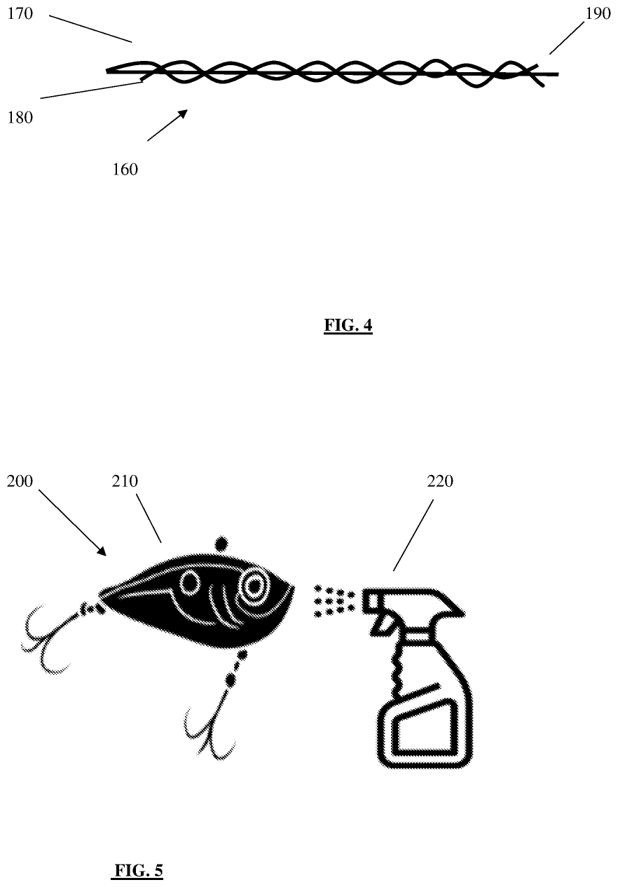

FIG. 5 illustrates an exemplary embodiment of a fishing lure 200 providing enhanced sonar visibility. In order to improve the capability of visually following an angler's lure while in the water, the lure 200 is provided with a sonar enhancing coating 210 of sonar signal-enhancing receptors. The coating 210 would coat the entire surface of the lure 200, or as much of the surface of any portion of the lure 200 as would be necessary to enable the angler to visually see/follow the lure's progress on their sonar device under prevailing conditions, whether in salt or fresh water. The sonar enhancing coating 210 can be applied to the body of the lure 200 via any liquid applicator, such as a conventional spray bottle 220. It is also contemplated that sonar enhancing coating 210 can be applied to the lure via aerosol, paint, or any suitable applicator of flowable materials. The sonar enhancing coating 210 can be composed of any suitable sonar enhancing material, or a combination of such materials. Examples of such materials include, but are not limited to aluminum, steel, lead, Mylar®, silver or other sonar reflective materials.

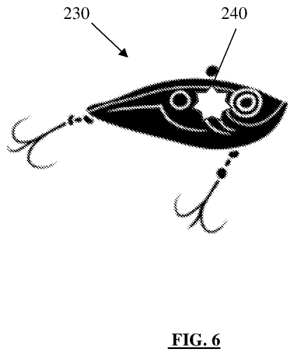

FIG. 6 illustrates an exemplary embodiment of a fishing lure 230 providing enhanced sonar visibility. In order to improve the capability of visually following an angler's lure while in the water, the lure 230 is provided with a sonar enhancing appliqué 240 of sonar signal-enhancing receptors. The appliqué 230 is adhered to the body or any suitable portion of the lure 230. The size of the appliqué 240 can be chosen to provide a sonar reflective area to as much of the surface of the lure 230 as would be necessary to enable the angler to visually see/follow the lure's progress on their sonar device under prevailing conditions, whether in salt or fresh water. The sonar enhancing appliqué 240 can be provided as a self-adhesive, pressure-sensitive sticker that can be applied to the lure as one would apply any known sticker to a surface. It is contemplated that the sonar enhancing appliqué 240 can be provided as a single sticker, a sheet of stickers of various sizes, or a single sheet that can be cut to a size and shape best suited to the lure being used. The sonar enhancing appliqué 240 can be composed of any suitable sonar enhancing material, or a combination of such materials. Examples of such materials include, but are not limited to aluminum, steel, lead, Mylar®, silver or other sonar reflective materials.

While exemplary embodiments of the present disclosure are provided herein, various changes and modifications can be made without departing from the spirit and scope of the disclosure. The scope of the disclosure is indicated in the appended claims, and all changes that come within the meaning and range of equivalents are intended to be embraced therein. For example, variations in the forming and/or any other features described in the present disclosure are within the spirit and meaning of the appended claims.

I claim:

1. Fishing line providing enhanced sonar visibility comprising:
a first material constructed from at least one material providing sufficient strength and flexibility to enable angling for the specific species being sought and the conditions under which angling is being performed; and
a second material composed of at least one substance that is more sensitive to sonar imaging than the first material.

2. Fishing line in accordance with claim 1, wherein the second material is chosen from a group comprising metals and Mylar®.

3. Fishing line in accordance with claim 1, wherein the fishing line comprises extruded materials.

4. Fishing line in accordance with claim 3, wherein the second material comprises particles distributed within the fishing line.

5. Fishing line in accordance with claim 3, wherein the first material and second materials are coextruded to form inner and outer layers.

6. Fishing line in accordance with claim 1, wherein the fishing line comprises a braided line composed of multiple strands, at least one of the strands being constructed from the first material, and at least one of the strands being constructed from the second material.

7. Fishing line in accordance with claim 6, in which the second material is chosen from a group comprising aluminum, steel, lead, and Mylar®.

8. A fishing lure providing enhanced sonar visibility comprising:
a lure body; and
at least one section of the lure body including a material more sensitive to sonar imaging than the material from which the lure body is made.

9. A fishing lure in accordance with claim 8, wherein the at least one section of the lure body including a material more sensitive to sonar imaging comprises a coating.

10. A fishing lure in accordance with claim 8, wherein the at least one section of the lure body including a material more sensitive to sonar imaging comprises an appliqué.
